(19) United States
(12) Patent Application Publication
(10) Pub. No.: US 2018/0189861 A1
(43) Pub. Date: Jul. 5, 2018

(54) A METHOD AND SYSTEM FOR OPTIMIZING PURCHASES OF SERVICES FOR CONSTRUCTION SITES

(71) Applicant: BUILD-E CONTRACTOR LTD, Maale Adumim (IL)

(72) Inventor: Roman Golub, Maale Adumim (IL)

(73) Assignee: BUILD-E CONTRACTOR LTD, Maale Adumim (IL)

(21) Appl. No.: 15/740,698

(22) PCT Filed: Jun. 29, 2016
(86) PCT No.: PCT/IL2016/050694

§ 371 Date: Dec. 28, 2017

(30) Foreign Application Priority Data
Jul. 2, 2015 (IL) 239763

(51) Int. Cl. G06Q 30/06; G06Q 10/08; G06Q 40/02

(52) U.S. Cl. CPC G06Q 30/0633; G06Q 40/025; G06Q 10/08345

(57) ABSTRACT

The present invention relates to a method for optimizing purchases of services related to construction sites, comprising: enabling constructors to provide requests that include items and quantities; enabling suppliers to provide offers to at least part of the items in each request; applying a cart comparison algorithm for ranging the cheapest available offers by said suppliers; applying a transportation comparison algorithm for finding the transport cost for each offer; generating range of packages corresponding to the request as provided by a specific constructor, wherein each package may include items from more than one supplier; and upon selecting a package by the constructor, executing an order to each supplier and transportation service that appears in the selected package.

### FIELD OF THE INVENTION

The present invention relates to the field of construction related management system. More particularly, the invention relates to a system and method for providing on-line mechanism (e.g., web or mobile) allowing contractors or other involved parties throughout the course of a building project, to search for and order building site services and products offered by providers, in particular a combined service package that include products from one or more suppliers and their transportation to the construction site form a transportation company. Moreover, the on-line mechanism allows comparing prices in every aspect related to the construction field, including insurance, professional workers, transportation services, heavy equipment rental, etc.

### BACKGROUND OF THE INVENTION

Typically, a construction contractor is responsible for buying construction materials from various suppliers. A supplier may supply the material only or also may provide in some cases the service of transporting the product to the construction site. The contractor provides the specification of the products needed which include type of material, size, shape, quantity, etc. The contractor also provides a deadline for which the construction products must be delivered to a specified construction site.

For relatively large projects, not all quantities of the products needed for the entire project are requested by the contractor to be delivered at one time. Typically, a schedule of delivery is set such that a specified set of goods are delivered in a manner which corresponds to the schedule of the project. A project to build a large condominium complex, for instance, may base the materials delivery schedule on the completion of each floor of the building. It is a customary practice for the contractor to be paid on an incremental basis as the project is being completed. Similarly, the supplier is also paid as and when the deliveries are made and after the documentation of the deliveries are properly verified by the contractor. Currently, there is no systematic method or system for verifying the deliveries. Hence, it is not unusual for the contractor to have long delays in making payments to the supplier, even when the deliveries have been correctly and promptly made.

Meeting the deadline of any order is absolutely critical if the construction project is to meet its scheduled completion date. Unfortunately, it is all too common in the industry to have many delays due to temporary insufficient inventory at the supplier side, and the failure of the constructor to find alternative products replacements from other suppliers to deliver the ordered good in a timely manner. In addition, the supplier may suffer from delay payments by the constructors due to the time it take the constructors to check the order papers and to approve them for payment.

Currently, the way the construction contractor makes an order from the construction supplier can broadly be viewed as being manual. Although it can be seen that a better system is needed, currently, no system is able to perform the above functions automatically as well as providing a comprehensive and optimized service to the construction contractor at a construction site to compare the combination of transportation services with products/services that can be ordered from a variety of product/service suppliers, including heavy equipment, alternative transportation services, workers, insurance and financial services.

Currently, although each order is documented, there is no automatic way of documenting each transaction in relation to the overall quantity information, and an easy way to communicate the information to the contractor. Furthermore, the process of tracing the order documents can be a tedious and time-consuming process, and so information such as consolidated quantities is hard to come by. Many of the delays in the delivery of ordered goods as well as other problems can be traced one way or another to the current method of obtaining quantity information, and the current method of transacting and documenting an order between the contractor and the supplier.

It is an object of the present invention to provide a system which is capable of optimizing transaction activities and supply of construction products and services.

It is another object of the present invention to provide a system which is capable of generating service packages that combine products ordering with alternative transportation services, thereby saving costs to the constructors and opening market channels to variety of suppliers while minimizing transportation limitation.

It is yet another object of the present invention to provide a system which enables to directly connect between constructors and service and product supplier.

Other objects and advantages of the invention will become apparent as the description proceeds.

### SUMMARY OF THE INVENTION

The present invention relates to a method for optimizing purchases of services related to construction sites, comprising: enabling constructors to provide requests that include items and quantities; enabling suppliers to provide offers to at least part of the items in each request; applying a cart comparison algorithm for ranging the cheapest available offers by said suppliers; applying a transportation comparison algorithm for finding the transport cost for each offer; generating range of packages corresponding to the request as provided by a specific constructor, wherein each package may include items from more than one supplier; and upon selecting a package by the constructor, executing an order to each supplier and transportation service that appears in the selected package.

The present invention relates to a system for facilitating purchases of services offered by service providers in the field of construction. The system includes an application server providing a network service that is accessible to a plurality of users through a plurality of client systems communicatively coupled to the application server via a network and a data storage system storing a service offer database that is maintained by the application server. The service offer database comprises a plurality of service offer information records respectively associated with a plurality of service offers.

The plurality of service offers includes at least one service offer for a bundled set of services that is dynamically adapted for each specific user while it considers the transportation of the ordered/purchased construction materials/equipment to a specific construction site. Each service offer information record comprises an indication of a primary service of the associated service offer, a purchase price for the associated service offer and a payment arrangement for the primary service.

Upon being accessed by a user of one of the client systems, the network service is operable to receive an indication from the client system of a selected service offer being selected from the plurality of service offers for purchase by the user. Upon receiving purchase information for the user specifying a funding source to use for purchasing the selected service offer from the client system, the network service is operable to issue a request to the funding source for funds corresponding to the purchase price included in the service offer information record associated with the selected service offer to process a purchase of the selected service offer by the user.

According to an embodiment of the present invention, the application server implements a web application to provide the network service, and each client systems implements a client application configured to provide a web-based user interface for accessing the network service provided by the application server via the web application.

Each service offer for a bundled set of services comprises a bundled set of construction materials, equipment and/or services provided by corresponding product suppliers (e.g., metal rods manufacture) and/or service providers (e.g., available trucks or other relevant transportation service), which may include transportation service of construction materials to the construction site, construction equipment, professional workers, etc.

In another aspect, the present invention relates to a system for optimizing purchases of services related to construction sites, comprising:
a) at least one processor; and
b) a memory comprising computer-readable instructions which when executed by the at least one processor causes the processor to execute a marketplace system, wherein the marketplace system:
   i) enables constructors to provide requests that include items and quantities;
   ii) enables suppliers to provide offers to at least part of the items in each request;
   iii) applies a cart comparison algorithm for ranging the cheapest available offers by said suppliers;
   iv) applies a transportation comparison algorithm for finding the transport cost for each offer;
   v) generates range of packages corresponding to the request as provided by a specific constructor, wherein each package may include items from more than one supplier; and
   vi) upon selecting a package by the constructor, executes an order to each supplier in the selected package and an order to transportation service.

According to another aspect, the present invention relates to a non-transitory computer-readable medium comprising instructions which when executed by at least one processor causes the processor to perform the method for optimizing purchases of services related to construction sites.

The above-described and other features and advantages realized through the techniques of the present disclosure will be better appreciated and understood with reference to the following detailed description, drawings, and appended claims. Additional features and advantages are realized through the techniques of the present invention. Other embodiments and aspects of the invention are described in detail herein and are considered a part of the claimed invention.

### BRIEF DESCRIPTION OF THE DRAWINGS

In the drawings:

FIG. 1 schematically illustrates network architecture of a construction site marketplace system, according to an embodiment of the present invention; and

FIG. 2 schematically illustrates the generation process of a bundle set of services in a flowchart form, according to an embodiment of the present invention.

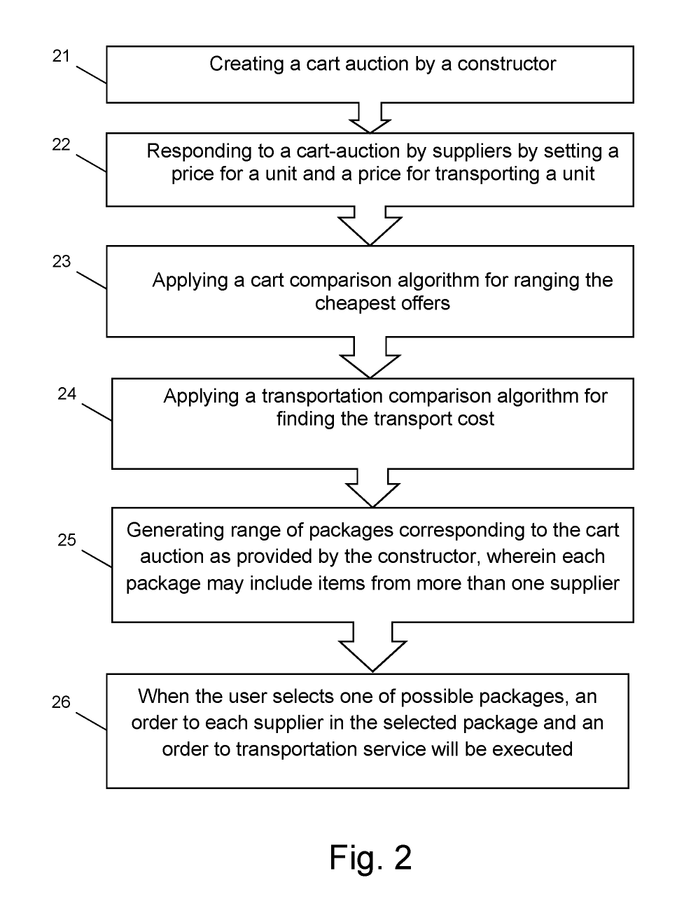

### DETAILED DESCRIPTION OF THE INVENTION

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

A transactional marketplace system in accordance with an embodiment of the present invention will now be described with reference to the drawings. Exemplary embodiments of the present invention may be implemented to provide construction site related service suppliers with a mechanism to offer services and products that are dynamically adapted to each specific contractor via a network-based application (for example, a web-based application). In this regard, exemplary embodiments may further be implemented to provide contractors with a mechanism to remotely search, compare, and make orders of such services and products offered by construction related service suppliers via a network-connected device configured to access the network-based application. Exemplary embodiments may be further implemented to provide a bundled set of construction services, optimized for each specific contractor, and that are performed separately by multiple providers to each individual constructor through such a network-based mechanism in which the constructor is provided the opportunity to select and order the best offer of such a bundled set of services in a single transaction via the network-connected device, whereby the network-based application facilitates a disbursed distribution of the payment among the multiple service providers that perform services included in the bundled set of services.

Exemplary embodiments may be further implemented to provide various types of construction related services, which may include rental services of heavy construction equipment such as heavy-duty vehicles, specially designed for executing construction tasks, hiring professional workers, transportation services of heavy construction material to construction sites, construction material suppliers, and insurance or other financial and credit arrangement, with the ability to establish affiliations with one another through such a network-based mechanism and provide various options allowing the service providers to remotely offer services in association with these affiliations.

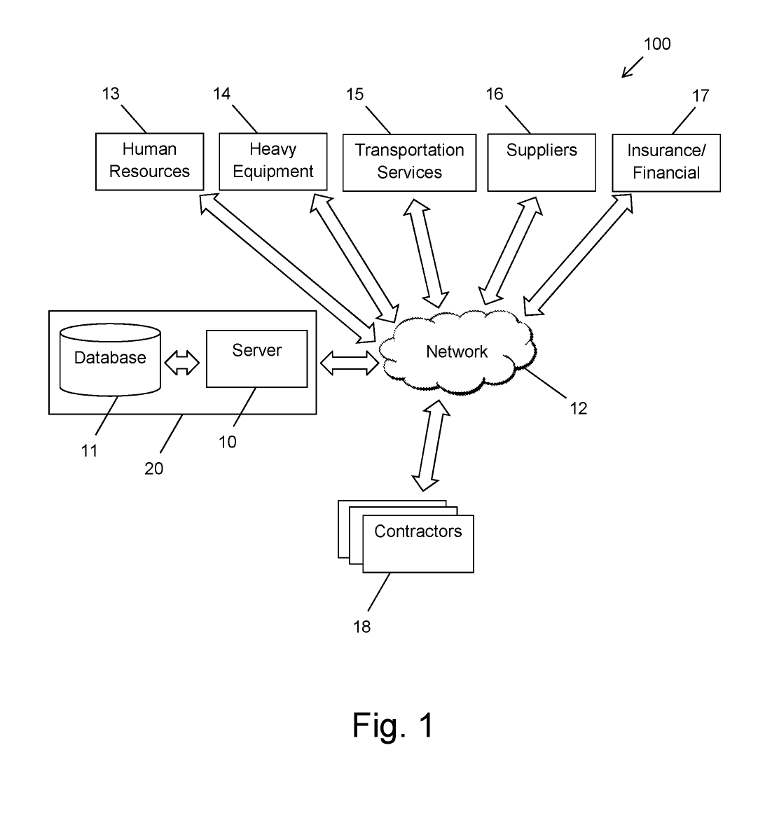

Referring now to FIG. 1, a schematic diagram illustrating network architecture for a construction site marketplace system 100 that can be configured to implement exemplary embodiments of the present invention is provided. It should of course be understood that FIG. 1 is intended as an example, not as an architectural limitation for different embodiments of the present invention, and therefore, the particular elements depicted in FIG. 1 should not be considered limiting with regard to the environments within which exemplary embodiments of the present invention may be implemented.

In the example illustrated in FIG. 1, system 100 is implemented as a client/server system that includes a central server system 20 that is commonly accessed by each user of the system through operation of any of a plurality of client systems 13-18 that are operatively coupled to the central server system via a communication network 12. Central server system 20 further includes an application server 10 and a database 11, and each client system 13-18 is a user terminal or other client device implementing software for and running a respective client application for accessing services provided via a network-based application (also referred to herein as a network service) implemented by application server 10. Such client applications may also be referred to as client modules, or simply clients, and may be implemented in a variety of ways. In exemplary embodiments, such client applications can be implemented as any of a myriad of suitable client application types, which range from mobile client applications (e.g., smartphones or tablets application) to web-based interfaces in which the user agent function is provided by a web server and/or a back-end program, for example, a Common Gateway Interface (CGI) program.

According to some embodiments of the present invention, marketplace system 100 may also include at least one third-party server system (not shown) to enable other functionality that may be accessed and utilized by server system 20 to provide and/or enhance the network service discussed herein. In exemplary embodiments, marketplace system 100 can include additional servers, clients, and other devices not shown in FIG. 1.

As will be appreciated by a person skilled in the art, the particular architecture depicted in FIG. 1 is provided as an example for illustrative purposes and, in exemplary embodiments, any number of client systems such as those indicated by numeral 13-18 may be connected to server system 20 at any given time via network 12, and server system 20 can comprise multiple server components and databases located within a single server system or within multiple server systems, where the multiple server systems are integrated with or accessible by users of client systems 13-18 as a distributed server system via network 12. The data stored within the database(s) can be stored locally in a client system and/or remotely in the server system(s).

In exemplary embodiments, network 12 can be configured to facilitate communications between server system 20 and client systems 13-18, as well as communications with and between other devices and computers connected together within marketplace system 100, by any suitable wired, wireless technology, or any suitable combination thereof, including, but not limited to, local area networks (LANs), wireless networks, wide-area networks (WAN), the Internet (a network of heterogeneous networks using the Internet Protocol, IP), and virtual private networks, and the network may also utilize any suitable hardware, software, and firmware technology to connect devices such as, for example, optical fiber, Ethernet, Wireless LAN, cellular or telephone line network. Such a network connection may contain any number of network infrastructure elements including routers, switches, gateways, etc., can comprise a circuit switched network, such as the Public Service Telephone Network (PSTN), a packet switched network, such as the global Internet, a private WAN or LAN, a telecommunications network, a broadcast network, or a point-to-point network, and may utilize a variety of networking protocols now available or later developed including, but not limited to the Transmission Control Protocol/Internet Protocol (TCP/IP) suite of protocols for communication.

In exemplary embodiments, application server 10, database 11, and any other servers employed within server system 20 and third-party servers utilized within marketplace system 100 can be implemented within any suitable computing system or systems such as a workstation computer, a mainframe computer, a server system, a server cluster, a distributed computing system, a cloud based computing system, or the like, as well as any of the various types of computing systems and devices described below with reference to the client systems 13-18.

Server system 20 may be implemented using any of a variety of architectures. For example, application server 10 and database 11 may also be implemented independently or as a single, integrated device. While the exemplary embodiment illustrated in FIG. 1 depicts application server 10 and database 11 as individual components, the applications provided by these components, or various combinations of these applications, may actually be server applications running on separate physical devices. In this regard, server system 20 may comprise a number of computers connected together via a network and, therefore, may exist as multiple separate logical and/or physical units, and/or as multiple servers acting in concert or independently, wherein each server may be comprised of multiple separate logical and/or physical units. In exemplary embodiments, server system 20 can be connected to network 12 through a collection of suitable security appliances, which may be implemented in hardware, software, or a combination of hardware and software.

As illustrated in FIG. 1, application server 10 is communicatively coupled to database 11. Database 11 may comprise a plurality of data store that can be maintained by a dedicated server, accessed by application server 10 via database services, and store information on a variety of matters that is utilized in providing the services offered via the network service provided by the application server 10, as described below in greater detail. As used herein, the term “data store”, “data storage unit”, “storage device”, and the like may refer to any suitable memory device that may be used for storing data, including manual files, machine-readable files, and databases. In exemplary embodiments, application server 10 and database 11 may implemented together a single computing device, implemented within a plurality of computing devices locally coupled to each other via a suitable communication medium, such as a serial port cable, telephone line or wireless frequency transceiver, implemented within a plurality of computing devices remotely coupled to each other via network 12, or any suitable combination thereof.

Client systems 13-18 are computer devices to which one or more users, which may be construction service providers offering services or products or contractors seeking to purchase or order services/products related to construction sites, have access. It should be noted that the term “user” is used herein to refer to one who uses a computer system, such as one of client systems 13-18. As described in greater detail below, client systems 13-18 are each operable by such users to access server system 20 via network 12 and act as clients to access services offered by the network service provided by the server system within exemplary marketplace system 100. For this purpose, each client system includes a respective client application that executes on the client system and allows a user to interact with server system 20 via application server 10.

In exemplary embodiments, the computer systems of client systems 13-18 can be any of a wide range of suitable computing devices such as one or more smartphones, tablet computers or other handheld, portable electronic devices or other mobile handsets, desktop computers, laptops, Personal Computers (PCs) running an Operation System (OS), and the like, or any other suitable information processing devices.

In general, during operation of system 100, a client system (e.g., a contractor dedicated client 18) first establishes a connection to server system 20 via network 12. Once the connection has been established, the connected client system may directly or indirectly transmit data to and access content from the application server 10. A user accessing application server 10 through the connected client system can thereby to use a client application to access services provided by the application server, which are described in greater detail below, via a user interface implemented by the client application within which the client application renders the information served by the application server 10.

According to some embodiments of the present invention, application server 10 can implement network service as a non-web client application (such as a mobile application), a web client application, or both to provide the services accessed by client systems 13-18 within server system 20, and the client applications can correspondingly be implemented as non-web client applications (e.g., dedicated application adapted to run on a smartphone or tablet computer), web client applications (e.g., dedicated website), or both for operation by users of the client systems to interact with application server 10 and access the services provided thereby. For example, application server 10 can comprise a web server configured to provide a web application for the respective client applications implemented on client systems 13-18 that are configured to provide web-based user interfaces for utilizing the services provided by the web server. For instance, the user interfaces of client applications implemented on client systems 13-18 can be configured to provide various options corresponding to the functionality offered in exemplary embodiments described herein through suitable user interface controls (for example, by way of menu selection, point-and-click, dialog box, or keyboard command). In one general example, the user interfaces may provide “send” or “submit” buttons that allow users of client applications to transmit requested information to application server 10 or to upload/update data to application server 10. The user interfaces can be implemented, for example, as a graphical user interface (GUI) that renders a common display structure to represent the network service provided by application server 10 for a user of a client platform.

According to an embodiment of the present invention, each type of user may obtain a user interface adapted or relevant to the specific needs of that user. For example, contractors may use a client system 18 that includes a user interface that enables them to provide service invitation requests, search for available services or products, manage and organize their orders, inventory and payments, etc. Suppliers may use a client system 16 that includes a user interface that enables them to provide offers, to compete with other suppliers, to participate in bids, to manage their inventory, etc. A transportation service provider user (e.g., drivers or trucks owners) may use a client system 15 that includes a user interface that enables them to provide their availability and capabilities of their vehicles to transport construction materials cargo, manage schedules, etc.

More specifically, in such an example, application server 10 can, for example, be configured to provide services via a web-based software application hosting a corresponding website that includes a number of web pages (e.g., screens), and client applications can comprise a web browser executing on client systems 13-18, such that the services provided by application server 10 are accessible to client systems 13-18 using the Internet or an intranet. Users of client systems 13-18 may thereby access the website provided by application server 10 by, for example, inputting or following a link to the uniform resource locator (URL) for the website in the web browser, which then enable users to display and interact with information and other content embedded within the web pages of the website provided by application server 10. The web-based software application can transmit information that can be processed by the web browsers to render a user interface dedicated to each type of user using, for example, browser-supported programming languages such as JavaScript, HTML or the like, and can communicate with the web browsers using, for example, HTTPS, POST and/or GET requests. The client applications and application server 10 may be configured so that information transmitted between client systems 13-18 and server system 20 can be encrypted and sent over a secure network connection.

According to an embodiment of the present invention, application server 10 can be implemented to provide a plurality of services via a constructor portal and a plurality of services via a service provider portal that may include human resources, heavy equipment suppliers, transportation services suppliers and construction materials suppliers. As described herein, application server 10 can be implemented to provide a respective set of services for constructors as well as enabling the constructers to provide/upload requests (herein cart auction) that may include many requested catalog items/products and quantities. Some of the services offered by application server 10 can be commonly applicable to and accessible by all types of users, while other services can be applicable to and accessible only by specific types of users.

For purposes of description, the terms “providers” and “suppliers” are used herein to refer to the general class of users that register with the system offer construction sites related services or products for purchase by contractors users (e.g., organization or individual contractor/subcontractor users that contracts with another organization or individual for the construction of a building, road or other facility) registered with the system, which can include human resources users, heavy equipment suppliers, transportation services suppliers and construction materials suppliers, and the like. According to some embodiments, constructors may act as suppliers by responding to cart auction of other constructors and offering them items they own and wish to sell.

According to an embodiment of the invention, the services or products for purchase are individually suggested for each constructor based on a cart auction provided by each specific constructor. The system sends the cart auction to each relevant supplier, such that each supplier is able to offer at least part of the items included in the cart auction. Upon receiving offers from the suppliers, the system generates variety of possible and optimized packages and their prices, each of which includes the price for the requested items (may include items from plurality of suppliers) and their transportation cost. Each package reflects a total cost for the entire items and their transportation to the construction site. The transportation may involve more than one transportation vehicle (e.g., two trucks) due to the quantity and size of the items. Therefore, the transportation calculation considers the cargo capabilities of each transportation vehicle while calculating the optimal packages and prices. Many different parameter are involved in such calculation including current location of transportation vehicles, location of items (might involve different suppliers at different locations), location of the construction site, cargo capabilities (e.g., weight limits and dimension of the truck, etc.), possible cargo sharing in cases the truck is not completely loaded and have room for additional delivery for a second constructor on the way to a first constructor, etc.

In addition, a user account for a particular provider or contractor can have any number of authorized users. As an example, an account established for a contractor can have the contractor as one of its users. It can also have hired staff working for the contractor as other authorized users. The other authorized users can log into the account and perform various actions with the permission and under the supervision of the contractor. A single construction company account may be established and shared by multiple staff members of the company. For purpose of illustration, there can be a designated user (for example, an account administrator) who is responsible for managing the account. The administrator can be provided with greater access rights within server system 20 with respect to the account. In exemplary embodiments, a particular client application or a particular client system that is utilized for accessing application server 10 can be respective to and customized for each type of user account. For example, the particular client application that is utilized for each type of account can be implemented to provide virtual computing platform that is specific to the services offered for that type of account.

The services provided via the contractor portal may include a registration and account management service, a navigation and search service, an auction and a live purchasing service, and the services provided via the provider portal may include a registration and account management service, an affiliation management service, a procedure management service, a product management service, a live selling service, and a transaction processing service. The system, via both portals, may enable constructor and suppliers to digitally sign on obligation contracts for long or short periods, to define and ensure the legal relationship between each constructor and each supplier.

According to an embodiment of the invention, in a live purchasing/selling service the constructor may capture special opportunities to save costs according to limited condition such as specific regions, time of day, type of product, etc. due to an already executed order by another constructor, where there is still left room on the transportation vehicle to deliver more items to additional constructor that may appear on the same route of the transportation vehicle. This type of sharing opportunity could be a great way to save money for the constructors as well as an option to increase profit for the supplier and the transportation service supplier. Such a scenario is actually referred to a real win-win situation for all the entities involved.

As discussed above, application server 10 can implement a web-based application (for example, hosting a corresponding website that includes a number of web pages), and a client system can include a web browser that renders a user interface implemented by the web-based application for allowing users access the services provided by the application server.

Database 11 may include a contractor profile database, a human resources profile database, a heavy equipment supplier profile database, a transportation service profile database, a supplier profile database, an insurance/financial credit database, an available services database, a service offer database, an available products database, a product offer database, a transaction information database, and one or more additional databases that may be used for storing any other suitable information that may be utilized by server system 20 (for example, system usage data, audit trail data, data used internally within the system by application server 10, and the like). In exemplary embodiments, the various databases can be maintained within database 12 and can be maintained as groups within one or more larger databases or maintained individually.

Application server 10 can be configured to maintain various types of information records within the plurality of databases. An information record may be, for example, a program and/or data structure that tracks various data related to a corresponding type of information record. As used herein, the terms “data,” “content,” “information” and similar terms may be used interchangeably to refer to data capable of being captured, processed, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

As noted above, different types of users can access server system 20. As such, application server 10 can be configured to maintain and manage account information records for a variety of types of users that register with the system according to certain categories of accounts. In the present exemplary embodiment, the contractor profile database is used to maintain account information records for contractor users that register with server system 20 to purchase services and products being offered by provider users registered with the system. For each contractor for which an account is registered with server system 20, various items of information relevant to the contractor, such as name, address or location information, contact information, billing information, and any other suitable identifying information, as well as a unique user name and password associated with the account that can be used to log into the account, can be included in the respective account information record for the contractor that is maintained within contractor profile database. The account information record for each contractor can also be associated with a unique customer account identifier within contractor profile database that is used by application server 10 for performing various operations.

The human resources profile database may be used to maintain account information records for Manpower Company or individual professional construction worker users (e.g., builders, carpenters, etc.) that register with server system 20 to offer the hiring of professional services for order by contractor users registered with the system. For each construction worker for which an account is registered with server system 20, various items of information relevant to the construction worker, such as name, practice specialty, availability, a profile picture, contact information, and other information that can be helpful for marketing the construction worker to contractors accessing the system, as well as a unique user name and password associated with the account that can be used to log into the account, may be included in the respective account information record for the construction worker that is maintained within human resources profile database. The account information record for each construction worker can also be associated with an account status and a unique construction worker account identifier within human resources profile database that is used by application server 10 for performing various operations.

The heavy equipment profile database can be used to maintain account information records for heavy equipment users that register with server system 20 to offer services provided by owners of heavy equipment or users authorized to operate such heavy equipment for hire/purchase by contractors users registered with the system. For each heavy equipment user for which an account is registered with server system 20, various items of information relevant to the equipment, such as type of equipment, location and availability hours, and any other suitable identifying information, as well as a unique user name and password associated with the account that can be used by the heavy equipment users to log into the account, may be included in the respective account information record for the heavy equipment users that is maintained within the practice group heavy equipment profile database.

Transportation services profile database is used to maintain account information records for driver or owners of transportation vehicle users that register with server system 20 to offer transportation services of construction materials and/or equipment to a construction site for purchase by contractors within marketplace system 100. For each transportation vehicle for which an account is registered with server system 20, various items of information relevant to the availability and capabilities of the transportation vehicle, such as maximum weight, maximum cargo size, current location, availability of drivers/vehicle, and any other suitable information, as well as a unique user name and password associated with the account that can be used by the driver/vehicle owner to log into the account, may be included in the respective account information record for the transportation service that is maintained within the transportation service profile database.

Available services database is used to maintain information records for various construction materials and products that can be offered by providers registered with server system 20 for purchase by contractors users registered with the server system. In exemplary embodiments, the respective information records for construction materials and products that are maintained in the available services database and the information that populates the respective information record for each product can be created and maintained by provider users of server system 20. For each product for which an information record is created, various items of information relevant to the product, such as product dimensions, weight per unit, cost information, product location (e.g., the location of a warehouse from which a transportation vehicle needs to load the product), a code number identifying the item/product, and any other suitable information may be included in the respective information record for the product that is maintained within the available services database.

Additionally, in exemplary embodiments, the information record for each product that is maintained within the available services database may further include an indication of the whether the service/product can be offered by providers within marketplace system 100 as an individual primary service or as a primary service of a bundled set of a plurality of services (for which a single payment for the bundled set of services will be disbursed to different provider for each of the services in the bundled set). In such embodiments, for each service for which the information record includes an indication that the service is offered as a primary service of a bundled set of services, various items of additional information relevant to the bundled set of services associated with the service that is indicated to be a primary service may be included in the respective information record for the primary service that is maintained within available services database. Such items of information relevant to the bundled set of services included in the respective information record for a primary service may include, for example, items of information describing one or more secondary services associated with the primary service (such as currently available transportation services as a secondary procedure identifier that is used by application server 10 to uniquely identify the particular secondary service in association with the unique procedure identifier for the primary service with respect to the location of the construction site), one or more procedure identifiers for other services/products for which an information record is maintained within the available services database that are considered to be secondary services associated with the primary service, an indication of whether location of each of the one or more secondary services (for which a single contractor payment for the bundled set of services will be disbursed among different respective providers for the services in the bundled set) is optional or required in association with location of the primary service. In addition, in such embodiments, for each service for which the information record includes an indication that the service is offered as a primary service of a bundled set of services, the cost information that is included in the respective information record for the primary service that is maintained within available services database can include dynamic cost information for each of the primary service, the one or secondary services, that can be dynamically changed according locations of the construction sites (i.e., final destination of the primary service), the current location and cargo capabilities of the transportation vehicle, and the location of the primary service (i.e., the location of the cargo to be loaded on the transportation vehicle).

Service offer database may be used to maintain information records for services/products that are being offered by providers registered with the system for purchase by contractors users registered with the system. In this regard, it should be noted that the same service may be separately offered by multiple different providers registered with the system and, thus, the service offer database can include multiple information records for the same service that are each associated with a different provider. For each offered service for which a respective information record is maintained within service offer database, various items of information relevant to the service being offered, such as the unique procedure identifier for the information record within the available services database for the service, the unique account identifier for the account information record (within other profile databases as described hereinabove) of the provider that is offering the service through the system, the unique driver/transportation vehicle account identifier for the account information record within the transportation service profile database of the driver user that will deliver the service, a location from which the service/product will be loaded on the vehicle, a location of the construction site, the unique account identifier for the account information record of the provider for which payment for the service when purchased through the system is to be directed, a payment amount to be transferred to the provider for which payment for performing the service is to be directed, additional descriptive information that may be provided by the provider offering the service, a procedure offer identifier that is used by application server 10 to uniquely identify the offering of the particular service by the provider within the system, and any other suitable information may be included in the respective information record for the offered service that is maintained within the service offer database.

The insurance/financial credit database may be used to maintain credit information records for each registered constructor that may serve all the suppliers or at least those who have a digitally signed contract with the constructor. The credit information records can be used as a financial guarantee for the suppliers, thereby ensuring that the liabilities of a constructor will be met till a limit of a certain amount of money. This enables the constructor to acquire goods and buy products from plurality of suppliers. In addition, the system may use the insurance/financial credit database as a financial management tool, thereby enabling an efficient and effective management of money (funds) in such a manner as to accomplish the objectives of the organization.

Additionally, in exemplary embodiments, the information records for offered services that are maintained within the service offer database can include information records that include additional information for services that are offered by providers registered with the system as a bundled set of services. In this regard, the information record for each offered service that is maintained within the service offer database may further include an indication of the whether the offered service is being offered as an individual primary service or as a primary service of a bundled set of a plurality of services (for which a single contractor payment for the bundled set of services will be disbursed among different respective providers for the services in the bundled set). In such embodiments, for each offered service for which the information record includes an indication that the service is being offered by a provider as a primary service of a bundled set of services, various items of additional information relevant to the bundled set of services associated with the offered service that is indicated to be a primary service may be included in the respective information record for the offered service that is maintained within the service offer database. Such items of information relevant to the bundled set of services included in the respective information record for an offered service within the service offer database that is indicated to be a primary service of a bundled set of services may include, for example, items of information for each secondary service such as the unique procedure identifier for the information record within the available services database for the secondary service (or the secondary procedure identifier that is included in the available services database to uniquely identify the particular secondary service in association with the unique procedure identifier for the offered primary service where the information record for the primary service being offered in the available services database includes an indication that the service is offered as a primary service of a bundled set of services), the unique provider account identifier for the account information record within the relevant provider profile database that will perform the secondary service, route calculations and other analysis/processing according to the locations (construction site, product warehouse, current transportation vehicle location), and an indication of whether performance of the secondary service is optional or required in association with performance of the primary service.

The generation process of a bundle set of service that considers transportation availability and cargo capabilities, including sharing among two or more contractors may involve the following:
Enabling to create a cart auction by a constructor, wherein a cart auction may include many requested catalog items and quantities (block 21);
Enabling suppliers to response to the cart-auction (block 22)—pluralities of suppliers can response to each cart-auction. For each catalog item the supplier may set a price for a unit and a price for transporting a unit;
Applying a cart comparison algorithm (block 23):
For each requested item in the cart the algorithm ranges the cheapest offer, where
K is the number of suppliers who offered the cheapest price on at least one item;
L is the lowest number of suppliers in order to supply all the items; X is the number of requested items;

L<K<X
Sᵢ is the number of supplier to assemble a cart;
B is the number of combinations to assemble a cart. B can be 2̂k due to:

$${2}^{k} = {\sum }_{s = 0}^{k} ( \begin{matrix}k \\ s\end{matrix} )$$

In this part, the algorithm will be optimized by some consumptions and thereby reducing the complexity. R is the reduced number of B. The result of this stage is a table that includes all the suppliers that participates in Rᵢ and a total price for X related to Rᵢ.
Applying Transportation comparison algorithm (block 24), wherein:
For each Rᵢ the algorithm has to compute the transport cost.
T stands for truck. Every truck has physical dimensions, truck type, cargo capabilities, etc.
P is the price of every truck. T belongs to a truck company. P depends on to parameters: Price for minimum distance and price for each kilometer (km) beyond the minimum distance.
Xᵢ is the item to be transported. Xᵢ has physical dimensions.
S_{χ} is a supplier that offers Xᵢ items.
C stands for companies that are capable to transport all Xᵢ from S_{χ}.
For each Rᵢ the algorithm examine the lowest P upon by C. The lowest
P depends on a loading algorithm that calculates if all Xᵢ items from S_{χ} can be transported by a single T or may require a number of trucks.
The result of this stage is a table that includes all the suppliers that participates in Rᵢ, a total price for X and a total transport cost related to Rᵢ; Generating range of packages corresponding to the cart auction as provided by the constructor, wherein each package may include items from more than one supplier (block 25);
Ordering stage (block 26)—when the user selects one of possible Rᵢ an order to each supplier S_{χ} in Rᵢ and an order to C will be executed.

A transaction information database can be used to maintain information records for purchases that have been made via the system by registered contractor users of services and products being offered by registered providers. For each purchase of a service or product that has been made using the system, various items of information relevant to the purchase may be included in the respective information record for the purchase that is maintained within the transaction information database. In general, the items of information relevant to each purchase that is included in the respective information record for the purchase that is maintained within the transaction information database can include, for example, the unique contractor account identifier of the account information record for the purchasing contractor within the contractor profile database, the unique procedure offer identifier of the information record for a purchased service within the service offer database, a purchase date, and a unique transaction identifier that is used by application server 10 to uniquely identify the information record for the purchase of the service or product within the system. For each purchase of a service that has been made using the system, the items of information relevant to the purchase included in the respective information record for the purchase that is maintained within the transaction information database may further include an indication of whether the purchase has been redeemed and, if the purchase has been redeemed, a redemption date.

Additionally, in exemplary embodiments, the information records for purchased services that are maintained within the transaction information database can include information records that include additional information for purchases and services that are offered by providers registered with the system as a bundled set of services.

As discussed above, application server 10 can implement a user interface so that users of connected client systems 13-18 can access various services provided by the application server with relative ease by operating a corresponding client application. In exemplary embodiments, the user interface can be a web-based user interface, implemented as a web-based software application hosting a corresponding website that provides a number of web pages (that is, screens) to offer the services implemented by application server 10 to users. For example, a user can access the corresponding website using a web browser implemented within a client application executing on a client system.

In exemplary embodiments, when any user, regardless of whether the user is registered with system 20 with any type of user account or a non-registered user, operates a client system to access application server 10 (for example, by launching a native client application or by using a web browser to submit a URL that provides a network address for application server 10), the application server can be configured with a default setting that directs the user to a home page for the services grouped within contractors portal, at which the user is presented with various options through a search interface to access functions provided by navigation and search service.

For example, a graphical user interface provided by such a home page may include a drop-down menu, a search entry field, a location entry field, and a search button. The drop-down menu provides a set of selectable options that allow the user to search for particular procedures offered by provider users registered with the system, particular products offered by suppliers users registered with the system, information on providers registered with the system, and information on available transportation services that are maintained within system. In exemplary embodiments, navigation and search service can be configured to use location information that may be gathered by any suitable location determining functionality implemented on the client system to provide a default location entry (for instance, address of the construction site) within the location entry field. In such embodiments, navigation and search service may be further configured to request permission from the user via the user interface to be able to access and utilize such location information for this purpose.

Exemplary embodiments of the present invention that are related to computer-implemented processes and computer systems corresponding to the above-summarized exemplary embodiments directed to an apparatus are also described and claimed herein.

Some portions of the exemplary embodiments described above are presented in terms of algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In addition, while certain user inputs or gestures are described as being provided via phone key presses, data entry via a keyboard, or by clicking a computer mouse or button, optionally, user inputs can be provided using other techniques, such as by voice or otherwise. The example screen layouts, appearance, and terminology as depicted and described herein, are intended to be illustrative and exemplary, and in no way limit the scope of the invention as claimed.

As will be appreciated by the skilled person the arrangement described in the figures results in a system which is capable of optimizing transaction activities and supply of construction products and services.

An additional advantage provided by the invention is the ability to save costs for contractor by enabling facilitating the use of the transportation services. For example, the system enables an operator of a transportation service to load cargo for several contractors that might be located on the same driving route (i.e., a sharing service for two or more contractors, in case the cargo capabilities of the transportation vehicle enable it).

All the above description and examples have been given for the purpose of illustration and are not intended to limit the invention in any way. Many different mechanisms and methods of analysis/processing a bundle set of service can be employed, all without exceeding the scope of the invention.

1. A method for optimizing purchases of services related to construction sites, comprising: enabling constructors to provide requests that include construction materials items and quantities; enabling suppliers to provide offers to at least part of the items in each request; applying a cart comparison algorithm for ranging the cheapest available offers by said suppliers; applying a transportation comparison algorithm for finding the cost of a transportation service for each offer, wherein said transportation comparison algorithm considers the physical dimensions, cargo capabilities route, current location and availability of vehicles to transport the construction materials items; generating range of packages corresponding to the request as provided by a specific constructor, wherein each package include items from at least one supplier; and upon selecting a package by the constructor, executing an order to each supplier in the selected package and an order to the transportation service.

2. A method according to claim 1, wherein each package reflects a total cost for the entire items and their transportation to the construction site.

3. A method according to claim 1, wherein the transportation involves more than one transportation vehicle due to the quantity and size of the items.

4. A method according to claim 1, wherein the transportation calculation considers the cargo capabilities of each transportation vehicle while calculating the optimal packages and prices.

5. A method according to claim 4, wherein the calculation includes parameters such as current location of transportation vehicles, location of items, location of the construction site, cargo capabilities, possible cargo sharing in cases the truck is not completely loaded and have room for additional delivery for a second constructor on the way to a first constructor.

6. A method according to claim 4, wherein the parameters for the calculation considers different suppliers at different locations.

7. A method according to claim 1, further comprising maintaining credit information records for each registered constructor that may serve all the suppliers or at least those who have a digitally signed contract with the constructor.

8. A method according to claim 7, wherein the credit information records are used as a financial guarantee for the suppliers, thereby ensuring that the liabilities of a constructor will be met till a limit of a certain amount of money.

9. A method according to claim 7, wherein the credit information records are used as a financial management tool, thereby enabling an efficient and effective management of money (funds) in such a manner as to accomplish the objectives of an organization.

10. A system for optimizing purchases of services related to construction sites, comprising:
a) at least one processor; and
b) a memory comprising computer-readable instructions which when executed by the at least one processor causes the processor to execute a marketplace system, wherein the marketplace system:
i) enables constructors to provide requests that include items and quantities;
ii) enables suppliers to provide offers to at least part of the items in each request;
iii) applies a cart comparison algorithm for ranging the cheapest available offers by said suppliers;
iv) applies a transportation comparison algorithm for finding the cost of a transportation service for each offer, wherein said transportation comparison algorithm considers the physical dimensions, cargo capabilities, route, current location and availability of vehicles to transport the construction materials items;
v) generates range of packages corresponding to the request as provided by a specific constructor, wherein each package include items from at least one supplier; and
vi) upon selecting a package by the constructor, executes an order to each supplier in the selected package and an order to the transportation service.

11. A non-transitory computer-readable medium comprising instructions which when executed by at least one processor causes the processor to perform the method of claim 1.
